(19) United States
(12) Patent Application Publication
(10) Pub. No.: US 2010/0011820 A1
(43) Pub. Date: Jan. 21, 2010

(54) VEHICLE ANTI-THEFT DEVICE INCLUDING AN EQUIPPED CASE AND METHOD FOR PRODUCING SAID CASE

(75) Inventor: Fabrice Giacomin, Creteil Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SECURITE HABITACLE, Creteil Cedex (FR)

(21) Appl. No.: 12/518,859

(22) PCT Filed: Dec. 14, 2007
(86) PCT No.: PCT/EP07/63972

§ 371 Date: Jun. 11, 2009

(30) Foreign Application Priority Data
Dec. 19, 2006 (FR) 0611107

(51) Int. Cl. B60R 25/02

(52) U.S. Cl. 70/252

(57) ABSTRACT

The invention relates to a vehicle anti-theft device including an equipped case forming part of an assembly for locking the steering column of a vehicle. The inventive anti-theft device includes: a mechanism which is housed at least partially inside a case and which comprises at least a stator/rotor assembly and a cam (32), whereby the rotor can be externally actuated using a key; and a member for controlling the locking of the vehicle steering column, which can move in translation. The anti-theft device also includes two moulded shells each comprising cavities that can receive at least part of the above-mentioned mechanism, said shells being assembled to one another along a mating surface that extends essentially axially in relation to the axis of rotation of the rotor and the displacement axis of the locking control member.

The present invention relates to a vehicle anti-theft device comprising an equipped case assembly that forms part of the composition of an assembly for locking the steering column of a vehicle.

It also relates to the method of creating said case.

A particular, but nonexclusive, subject of the invention is a motor vehicle steering lock comprising a case in which a rotor is mounted such that it can rotate between an angular position of rest (also known as the stop position) in which a suitable key can be inserted axially from front to rear, or withdrawn axially from the rear forward, and at least one angular position of use, in which the key cannot be extracted from the rotor. The rotor comprises a rotary output member that forms a cam which is capable of collaborating with a control finger borne by a pull lever in order to control the movement of this lever. The pull lever is mounted such that it can slide in the case in an axial direction, between a forward anti-theft position toward which it is elastically urged and in which it projects axially forward through an opening in the case to prevent one member of the steering column from turning when the rotor is in the rest position, key extracted, and a rear position retracted inside the case.

Conventionally, the case is made of a single piece or in several parts that are separated by one or more substantially radial planes. The main elements internal to the case, such as the cam, are mounted axially. This type of design springs naturally to mind because it follows from the established art relating to the standard manufacture by machining using lathes or milling machines. According to the prior art, subassemblies such as the pull lever equipped with the rocking finger were mounted longitudinally, parallel to the axis of rotation of the rotor. This design means that ever increasing cylindrical surface stages need to be designed in order to create a part that can easily be released from the mold axially and allow the internal subassemblies of the case to be fitted axially. Furthermore, this design entails providing clip-fastening in order to hold the various subassemblies axially in position once they have been placed inside the case, because

main elements internal to the case, such as the cam, are mounted axially. This type of design springs naturally to mind because it follows from the established art relating to the standard manufacture by machining using lathes or milling machines. According to the prior art, subassemblies such as the pull lever equipped with the rocking finger were mounted longitudinally, parallel to the axis of rotation of the rotor. This design means that ever increasing cylindrical surface stages need to be designed in order to create a part that can easily be released from the mold axially and allow the internal subassemblies of the case to be fitted axially. Furthermore, this design entails providing clip-fastening in order to hold the various subassemblies axially in position once they have been placed inside the case, because its subassemblies have a natural tendency to come back out of their housings following longitudinal insertion. This design therefore imposes constraints concerned with mold creation and constraints relating to the need to provide numerous clip fastenings, and therefore increases the overall size, cost and mass of the whole. Furthermore, this design means that complex kinematic assemblies in which the axes of rotation and of translation are not coaxial cannot be used in a one-piece body. Further, this design does not make it possible to create lightening cavities without additional cost and without the removal of material from the exterior shape. This is because material situated on the outside of the case is needed in order to provide the whole with its rigidity and bending strength.

In order to remedy these disadvantages, the invention breaks with the tradition relating to the designs already mentioned and proposes a motor vehicle anti-theft device, comprising, housed at least partially inside a case, a mechanism comprising at least one stator/rotor assembly and a cam, the rotor being operable from the outside via a key, and a vehicle steering column locking control member, this control member being translationally mobile, the case being made up of at least two molded shells each comprising cavities capable of at least partially accommodating said mechanism, these shells being assembled with one another along a joining surface which extends substantially axially relative to the axis of rotation of the rotor and to the axis of movement of the locking control member.

In some nonlimiting embodiments, the invention exhibits the following additional features considered in isolation or in combination:
the at least two shells may be made of pressure die cast plastics.
the pressure die cast plastics used may include high-strength fibers.
the shells may be assembled using snap-fastening means.
the shells may be assembled using welding means.
the welding means may be means using laser beams.
means of attaching a switching module may be present on each of the two parts provided on two respective shells.
the stator/rotor assembly may comprise a rotor made of plastic and an intermediate stator made of metal.
the rotor may be clipped onto the cam.
magnetic shielding may be placed over part of the case when the case is assembled.

The invention also proposes a method of creating a case assembly for a vehicle anti-theft device that forms part of an assembly for locking the steering column of a vehicle, comprising, housed at least partially inside a case, a mechanism comprising at least one stator/rotor assembly and a cam, the rotor being operable from the outside via a key, and a vehicle steering column locking control member, this control member being translationally mobile, the method comprising an operating sequence involving:
A) a manufacturing step involving:
   creating the at least two molded shells, namely a first shell, comprising a first longitudinal joining surface which extends substantially axially relative to the axis of rotation of the rotor and to the axis of movement of the locking control member, and a second shell, comprising a second longitudinal joining surface which extends substantially axially relative to the axis of rotation of the rotor and to the axis of movement of the cam the locking control member
   creating a mechanism comprising
      the stator/rotor assembly
      the cam
      the key
      the control member
B) an assembly step involving:
   radially inserting at least
      the cam
      the locking control member in the first shell
C) a fastening step involving positioning and joining the at least two shells, making the first longitudinal planar joining surface coincide with the second.

Advantageously, the invention exhibits the following additional features taken in isolation or in combination:
the step that consists in manufacturing the at least two shells may involve the high-pressure injection molding of plastics, possibly filled with high-strength fibers,
the step that consists in joining the at least two shells together may consist in at least one clipping of the first shell onto the second shell in order to join the two together after the internal subassemblies have been inserted radially,
the step that consists in joining the at least two shells together may be performed by welding along part of the plane of contact of the longitudinal planar joining surfaces of the two shells,
the step that consists in joining the at least two shells together by welding may be performed using laser beams,
furthermore, an additional step may consist in placing a contactless switch on the case which is clipped on after the two shells have been assembled,
furthermore, an additional step may consist in placing magnetic shielding over part of the case when the latter has been assembled.

One embodiment of the invention will be described hereinafter by way of nonlimiting example with reference to the attached drawings in which:

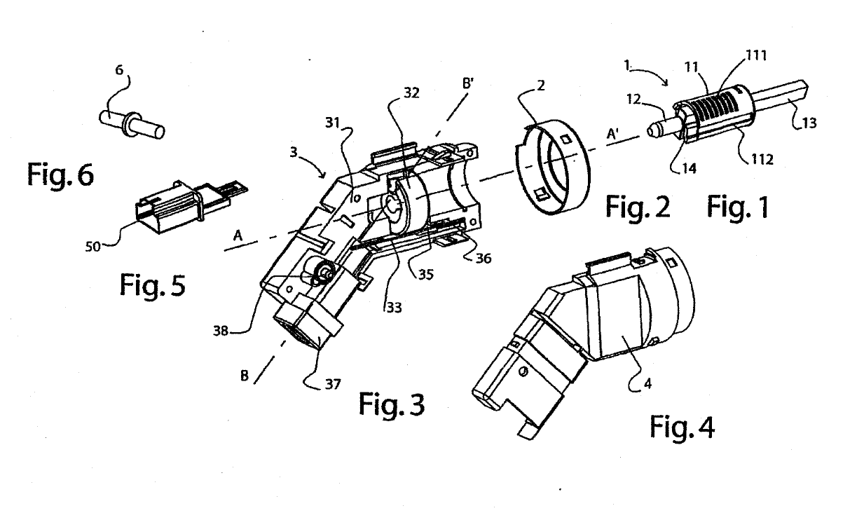

FIG. 1 is a simplified perspective view of a stator/rotor assembly.

FIG. 2 is a simplified perspective view of a circular magnetic shielding cap.

FIG. 3 is a perspective view of the first shell complete.

FIG. 4 is a perspective view of the second shell.

FIG. 5 is a perspective view of the switching module.

FIG. 6 is a perspective view of the preemption finger.

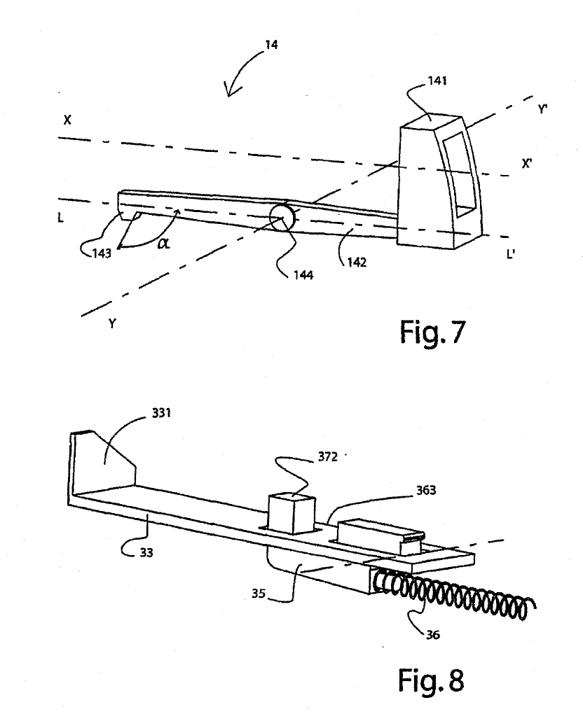

FIG. 7 is a schematic perspective view of a rocking lever.

FIG. 8 is a schematic perspective view of a pull lever equipped with a rocking finger.

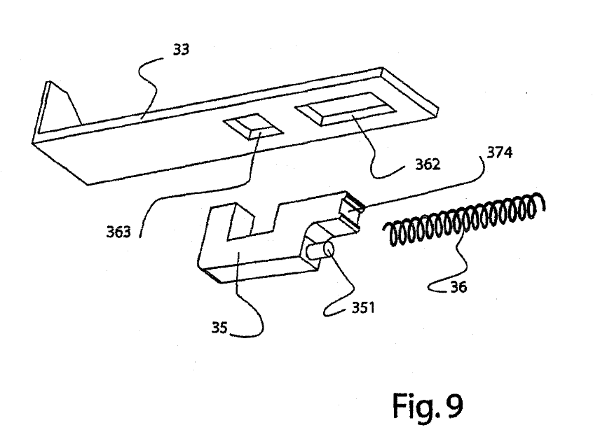

FIG. 9 is a exploded schematic view of the pull lever, of the rocking finger and of the spring.

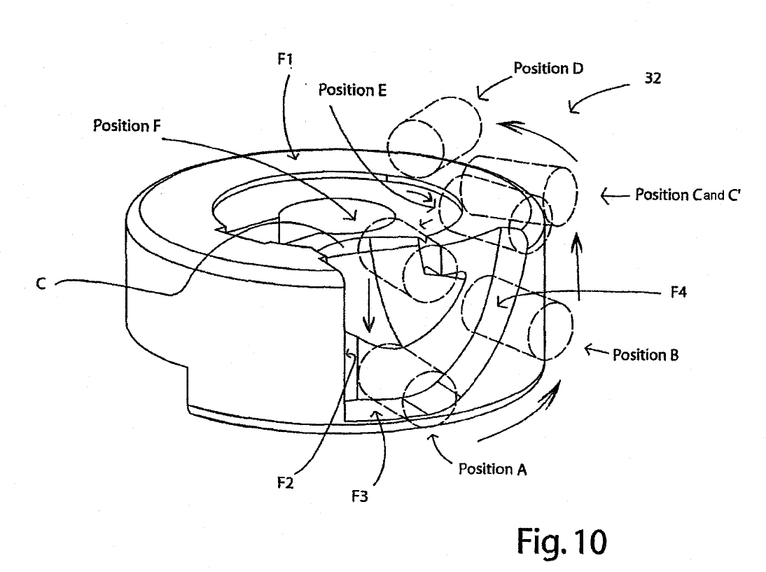

FIG. 10 is a schematic perspective view of a cam mounted at the end of a rotor.

In this embodiment, the anti-theft case is made up of two shells made of molded plastic.

These two shells 3 and 4 are intended to be assembled with one another at the assembly plane and each comprise two parts the axes of which run obliquely to one another, namely:
a first part of axis AA′ which comprises, opening onto the assembly plane, a stepped semicylindrical recess intended to accommodate a stepped barrel assembly and a longitudinal cavity which runs parallel to the axis of the cylindrical recess, this cavity being intended to accommodate a pull lever/rocking finger/spring assembly
a second part of axis BB′ comprising a substantially parallelepipedal cavity opening onto the plane of assembly running parallel to the axis BB′ and intended to accommodate a bolt guide in which a bolt is mounted such that it can slide along the axis BB′. This second part further comprises a housing intended to accommodate a preemption finger complete.

Moreover, the first part of each of the shells comprises, on its exterior face, a half profile for a snap-fastening assembly which here comprises a half slideway followed by a snap-fastening detent. The assembly profile created by the two half profiles serves to accommodate a switching module which is slid into the two half slideways and snap-fastened onto the series of catches at the end of its travel.

The two shells are fixed together along the assembly faces by any known means such as bonding, welding, fusing.
The stator/rotor complete assembly, also known as the barrel assembly 1 in this embodiment comprises a plastic rotor 12 of circular shape comprising, at its center a recess into which a key 13 can enter. The rotor further comprises slots housing tumbler springs (not shown in the figure for reasons of clarity). A cylindrical protrusion with the same axis as the rotor extends the rotor on its opposite side to the keyhole. A system of clipping is provided on the opposite side to the keyhole in order to secure the rotor to the cam.

In this example, the barrel assembly comprises at its periphery an intermediate metal stator 11 comprising recesses 111 for the passage of the tumbler springs and a slot 112 for the passage of the rocking lever. In this instance, the rotor is made of plastic and produced by injection molding. In this instance the intermediate stator is, for its part, made of molded “Zamak” (registered trade name).

The barrel assembly is clipped to a cam 32 made of “Zamak” (registered trade name).

The magnetic shielding cap 2 here is made of magnetic low-carbon steel. It is obtained by pressing from a thin sheet. Tabs are provided so that this cap can be fixedly positioned by clipping onto the front face of the case of the anti-theft device once it has been fitted. It comprises a central orifice through which the key 13 can pass.

The first shell 3 comprises a front part of substantially semicylindrical shape of axis AA′ comprising a half counterbore again of substantially semicylindrical shape, designed to house the cam 32 and the barrel assembly 1. A semicylindrical cavity is provided in the bottom of this counterbore to act as a bearing for the protrusion from the rotor. A longitudinal half slot is provided to house and guide the translational movement of a pull lever 33 comprising a rocking finger 35 and a compression spring 36. This spring pushes the pull lever toward the back of the lock on the opposite side to the keyhole, and also pushes the rocking finger toward the inside of the lock.

This first shell 3 also comprises a rear part of substantially semi-parallelepipedal shape with a longitudinal axis that is inclined with respect to the axis AA′. This first shell 3 also comprises a longitudinal cavity to accommodate the half of the bolt guide and part of the half of the bolt itself. This shell also comprises a circular orifice able to accommodate a cylindrical grasping finger 6 comprising a cylindrical shoulder and a compression spring.

The second shell 4 comprises a front part of substantially semicylindrical shape of axis AA′ comprising a half counterbore again of substantially semicylindrical shape, designed to house the cam 32 and the barrel assembly 1. A semicylindrical cavity is provided in the bottom of this counterbore to act as a bearing for the protrusion from the rotor. A longitudinal half slot is provided to house and guide the translational movement of a pull lever 33 comprising a rocking finger 35 and a compression spring 36. This second shell 4 also comprises a rear part of substantially semi-parallelepipedal shape with a longitudinal axis that is inclined with respect to the axis AA′. This second shell 4 also comprises a longitudinal cavity to accommodate the half of the bolt guide and part of the half of the bolt itself. This shell also comprises a circular orifice able to accommodate a cylindrical grasping finger comprising a cylindrical shoulder.

The rocking lever 14 comprises:
a yoke 141 comprising an orifice through which the key can pass. The internal surface of the orifice cooperates with the key to position itself in a raised position when the key is in the rotor, and position itself in a lowered position when the key is removed from the rotor
a lever finger 143 comprising a contact face inclined by an angle α, here of 105 degrees, with respect to the axis LL′ of the rocking lever 142 and situated on the opposite side of the axis YY′ of the rocking lever to the yoke
a body 142 of elongate linear form, connecting the yoke 141 to the lever finger 143
two stubs 144 positioned substantially at the center of the lever and forming the pivot about the axis YY.

The spring 36 works in compression. It presses at one of its ends against a protrusion 351 of the rocking finger and at the other end against the bearing surface of the case.

The pull lever 33 comprises, at one end, a part 331 via which it can be connected to a vehicle steering lock device, and at the other end two successive orifices, namely a rear orifice 362 of rectangular shape and a front orifice 363 of rectangular shape.

The rocking finger 35 comprises a one-piece body exhibiting, on one side, two successive protrusions that fit through the two orifices respectively,
the protrusion 372 of substantially parallelepipedal shape constitutes an immobilizing member which collaborates with the lever finger,
the protrusion 363 serves to provide the pivoting connection between the body of the rocking finger 35 and the pull lever 33. Of substantially parallelepipedal shape it has a concave region 374 in which a rim of the orifice of the slide engages so as to form a hinge about which the rocking finger 35 can rock.
a rest for spring 351 is positioned on the rocking finger.

The cam 32 here is made of “Zamak” (registered trade name) by pressure die casting in a metal die. It could be made of plastics, possibly filled with high-strength fibers. It comprises a helicoid ramp for guiding a rocking finger which is secured in terms of longitudinal translation to the pull lever. This cam is penetrated by the cylindrical protrusion of the rotor of the barrel assembly and is held together with the rotor by clipping. This cam has a body of cylindrical overall shape coaxially with the rotor, comprising a cavity opening onto the cylindrical face via an orifice delimited, in succession, starting from a first radial face F1 of the body, by an axial face F2, a radial face F3 extending a short distance from the second radial face of the body, and a substantially helicoid curved face F4 which ends at the first radial face of the body. The bottom of the cavity has, on the same side as the first radial face of the body, a cylindrical portion adjacent to the curved face followed by a concave region or opening of substantially parallelepipedal shape. It also has a dished shape C constituting a kind of ramp to guide the rocking finger from the concave region to the cylindrical radial face in a path that comprises a radial portion that brings the finger against the curved face, then a curved portion along the curved face in order finally to reach the cylindrical portion before returning into line with the concave region of the first radial face before coming back to face the concave region. FIG. 10 describes in greater detail the various steps and the relative position of the rocking finger with respect to the cam. With the finger in position A, the key engaged, turning the key causes the rotor and the cam to turn. The finger, by following the ramp along the cam (position B), takes the slide with it longitudinally. In position C the rocking finger rocks and comes closer to the axis of rotation of the rotor toward position C′. As the key and therefore the rotor continues to turn, the finger is kept in a stable longitudinal position as far as position D. When the key is returned to the stop position in order to be removed, having run along the surface F1 via the position E, the finger reaching position F, urged by the compression spring, is driven by the ramp of the return cam toward the stop position as soon the key is inserted in the rotor.

The pull lever 33 is made of steel and is obtained by cutting and pressing in a single operation starting from a thin sheet. The pull lever complete comprises a rocking finger 33 of which the finger 372 collaborates with the helical slot of the cam and a compression spring 36 which transmits to the pull lever a backward longitudinal force and transmits a centripetal force to the rocking finger.

The bolt is made of steel. It is mechanically connected to the pull lever 33. It is of substantially parallelepipedal shape and slides in the cavity provided for this purpose in the two half cases. The bolt acts on a vehicle steering lock finger (not depicted).

The bolt guide 37 is here made of “Zamak” (registered trade name). It is obtained by pressure die casting in a metal die. It is lodged in the cavity provided for this purpose in the two half cases. A parallelepipedal interior orifice serves to guide the bolt.

The preemption finger complete 38 comprises an axle 6 comprising a shoulder and a compression spring. This finger is positioned in an orifice in the case provided for this purpose.

The switching module 50 comprises an electronic circuit including at least one “Reed” switch sensitive to magnetic fields, together with a three-pin connector, all protected by a plastic case. This contactless switch is guided and clipped into a slot formed after the two half cases have been assembled, this slot being positioned on the outside of the case in a region close to the cam which bears the magnetic elements that influence the “Reed” switches.

The subassemblies are assembled as follows once the subassemblies have been manufactured:

First of all, the first shell is completed. The cam, the pull lever complete, the bolt guide and the bolt are positioned radially in the housings provided for that purpose in the first shell. The second shell is positioned against the first shell by bringing the joining planes of the two half cases into contact with one another. Retaining clips hold the at least two shells together temporarily. Laser welding along at least part of the visible edges of the joining planes gives the case assembly the rigidity and strength needed for the whole entity to operate correctly.

The magnetic shielding cap is then clipped over the front part of the assembled case.

The contactless switch is positioned in the slot of the case provided for this purpose.

The case complete is therefore fully assembled.

It is then possible to finalize the lock immediately or later on by axially inserting the barrel complete in the case complete. The complete barrel assembly is then introduced axially into the case. It enters via the entry of the lock and the cylindrical protrusion of the rotor becomes housed in the cylindrical cavity provided for that purpose in the case and becomes joined to the cam.

The way in which such a device works is as follows:
In the position of rest prior to use the key is withdrawn from the rotor. The spring pushes on the rocking finger which in turn pushes the pull lever outward.
Introducing the key into the yoke of the rocking lever forces against the upper internal surface of the yoke. This causes the rocking lever to pivot about its pivot point and therefore causes the finger 141 to move down.
As the key is turned, the rocking finger follows the cam (surface F4). The pull lever therefore moves toward the front of the rotor until the rocking finger reaches the internal face of the cam (surface F1). The pull lever is then in the retracted position.
Returning to the stop position, the rocking finger follows the internal face (surface F1) of the cam which is a planar surface perpendicular to the axis AA′. During this movement, the rocking finger and the pull lever do not move. The pull lever remains in the retracted position. On arrival near the stop position the rocking finger no longer presses against the front face of the cam but presses against the front face of the lever finger thus preventing the rocking finger from entering the axial slot (C) of the cam.
When the key is withdrawn, the spring pushes the rocking finger which has a tendency to apply an axial pressure to the lever finger and, given the respective slopes, has a tendency to cause the lever to pivot in order to raise the lever finger into a cavity in the cam provided for that purpose and thus clear the path so that the rocking finger and the pull lever, both pushed by the spring, can move back.

It may be seen that it is possible to create a complete vehicle anti-theft device case assembly that consists of the assembly of two shells that meet along a longitudinal joining plane. Manufacture of the two shells is simplified insofar as the shapes of the components involve very few undercuts. In addition, the internal subassemblies are easy to fit insofar as they are fitted radially rather than axially. It is also possible to provide additional weight-saving cavities without having to hollow out the exterior part which is needed to afford the case its rigidity and bending strength.

A person skilled in the art will be able to apply this concept to numerous other similar systems without departing from the scope of the invention defined by the attached claims.

1. A motor vehicle anti-theft device, comprising:
housed at least partially inside a case, a mechanism comprising at least one stator/rotor assembly and a cam, the rotor being operable from the outside via a key, and
a vehicle steering column locking control member, wherein the control member is translationally mobile,
wherein the case is made up of at least two molded shells each comprising cavities capable of at least partially accommodating said mechanism, wherein the shells are assembled with one another along a joining surface which extends substantially axially relative to the axis of rotation of the rotor and to the axis of movement of the locking control member.

2. The anti-theft device as claimed in claim 1, wherein the at least two shells are made of pressure die cast plastics.

3. The anti-theft device as claimed in claim 2, wherein the pressure die cast plastics used include high-strength fibers.

4. The anti-theft device as claimed in claim 2, wherein at least two shells are assembled using snap-fastening means.

5. The anti-theft device as claimed in claim 2, wherein, at least two shells are assembled using welding means.

6. The anti-theft device as claimed in claim 5, wherein the welding means use laser beams.

7. The anti-theft device as claimed in claim 1, wherein means of attaching a switching module are present on each of the two parts provided on two respective shells.

8. The anti-theft device as claimed in claim 1, wherein the stator/rotor assembly comprises a rotor made of plastic and an intermediate stator made of metal.

9. The anti-theft device as claimed in claim 1, wherein the rotor is clipped onto the cam.

10. The anti-theft device as claimed in claim 1, wherein magnetic shielding is placed over part of the case when the case is assembled.

11. A method of creating a case assembly for a vehicle anti-theft device that forms part of an assembly for locking the steering column of a vehicle, comprising, housed at least partially inside a case, a mechanism comprising at least one stator/rotor assembly and a cam, the rotor being operable from the outside via a key, and a vehicle steering column locking control member, this control member being translationally mobile, wherein the method comprises an operating sequence involving:
a manufacturing step involving:
creating the at least two molded shells, namely a first shell, comprising a first longitudinal joining surface which extends substantially axially relative to the axis of rotation of the rotor and to the axis of movement of the locking control member, and a second shell, comprising a second longitudinal joining surface which extends substantially axially relative to the axis of rotation of the rotor and to the axis of movement of the cam the locking control member; and
creating a mechanism comprising the stator/rotor assembly, the cam, the key, and the control member,
an assembly step involving:
radially inserting at least the cam and the locking control member in the first shell, and
a fastening step involving positioning and joining the at least two shells, making the first longitudinal planar joining surface coincide with the second.

12. The method as claimed in claim 11, further comprising manufacturing the at least two shells by the high-pressure injection molding of plastics, filled with high-strength fibers.

13. The method as claimed in claim 11, wherein joining the at least two shells together comprises clipping at least one of the first shell onto the second shell in order to join the two together after the internal subassemblies have been inserted radially.

14. The method as claimed claim 11, wherein joining the at least two shells together is performed by welding along part of the plane of contact of the longitudinal planar joining surfaces of two shells.

15. The method as claimed in claim 14, wherein joining the at least two shells together by welding is performed using laser beams.

16. The method as claimed in claim 11, further comprising placing a contactless switch on the case after the two shells have been assembled.

17. The method as claimed in claim 11, further comprising placing magnetic shielding over part of the case when the latter has been assembled.
